(19) United States
(12) Patent Application Publication
(10) Pub. No.: US 2017/0131895 A1
(43) Pub. Date: May 11, 2017

(54) IMAGE-SHOWING SYSTEM

(71) Applicant: Jun-Wei Su, Taichung City (TW)

(72) Inventor: Jun-Wei Su, Taichung City (TW)

(21) Appl. No.: 15/340,331

(22) Filed: Nov. 1, 2016

(30) Foreign Application Priority Data
Nov. 5, 2015 (TW) 104136554

(51) Int. Cl. G06F 3/0488; G06T 7/40; G06K 9/00; G06F 3/0486

(52) U.S. Cl. CPC G06F 3/04883; G06F 3/0486; G06T 7/408; G06K 9/00228; G06F 2203/04803; G06F 2203/04808

(57) ABSTRACT

An image-showing system is provided for a smart device equipped with a touch panel. The image-showing system provides images to be reviewed by a user according to preferences set by the user on the touch panel. The image-showing system includes an identifying unit, a labeling unit, an operation interface and an executing unit. The identifying unit identifying characteristics of each of the image files ready by the image-showing system. The characteristics include facial area, color uniformity and date/time. The labeling unit provides each of the image files with two different labels. Each of the labels is a facial area label, a color uniformity label or a date/time label. The operation interface receives a touch command from the user via the touch panel. The executing unit builds a review list and shows the image files on the review list according to the touch command and the labels.

### BACKGROUND OF INVENTION

### 1. Field of Invention

The present invention relates to an image-showing system for use in a smart device equipped with a touch panel and, more particularly, to a system for showing images according to preferences set by a user on a touch panel.

### 2. Related Prior Art

In a file management system of a computer or smart mobile device (the “device”), image files are shown on a screen in a certain order. The image files are arranged in an ascending or descending order of time or file names and represented by names or thumbnails on a list. A receiver can select and show an image in an enlarged scale by clicking a file name or thumbnail.

Problems have been encountered in using the above-mentioned process for reviewing or searching for images.

Firstly, a user cannot know what image is wrapped in a file via the file name or date/time and will not know what the image looks like until clicking and opening the file.

Secondly, a user has to review a lot of thumbnails to locate a desired one because the thumbnails are arranged in an order of date/time or file names.

Thirdly, the conventional management system provides a function for automatically displaying the thumbnails; however, it can only show the thumbnails in an order of time or file names.

Fourthly, there are some image-editing and displaying software programs operable for aggregating, editing and showing images. However, such a software program involves a complicated and cumbersome process that includes selecting, aggregating, classifying, editing and setting display orders and requires a user to operate, learn and practice skills for using the software program.

Fifthly, a typical file management system or an image-editing and playing software program does not allow the user to execute a simple operation, at any time, to quickly build a desired display list and automatically display the images to be reviewed by the user.

The present invention is therefore intended to obviate or at least alleviate the problems encountered in the prior art.

### SUMMARY OF INVENTION

It is an objective of the present invention to provide a system and process for showing groups of images to be reviewed by a user according to preferences set by the user on a touch panel.

It is another objective of the present invention to provide an image-showing system and process that allow a user to set preferences by clicks and drag-and-drops on a touch panel so that the system immediately builds a review list of images according to the preferences and automatically and sequentially shows the images on the list.

To achieve the foregoing objectives, an image-showing system is provided for use on a computer or smart device equipped with a touch panel. The image-showing system shows a group of images to be reviewed by a user according to preferences set by the user on the touch panel. The image-showing system includes a reading unit, an identifying unit, a labeling unit, an operation interface, a thumbnail-showing unit and an executing unit. The identifying unit identifies characteristics of each image file. The characteristics include facial area, color uniformity and date/time. The labeling unit provides each image file with first and second labels according to the characteristics obtained via the identifying unit. The first and second labels are selected from a facial area label, a color uniformity label and a date/time label. The first and second labels are different labels. The operation interface receives a touch command from the user via the touch panel. According to the touch command received by the operation interface, the executing unit uses the first and second labels to build a review list and shows the images on the review list.

Other objectives, advantages and features of the present invention will be apparent from the following description referring to the attached drawings.

### BRIEF DESCRIPTION OF DRAWINGS

The present invention will be described via detailed illustration of the preferred embodiment referring to the drawings wherein:

FIG. 1 is a front of a first interface of a system according to the preferred embodiment of the present invention;

FIG. 2 is a front of a second interface of a system according to the preferred embodiment of the present invention;

FIG. 3 is a front of a third interface of a system according to the preferred embodiment of the present invention; and

FIG. 4 is a front of a fourth interface of a system according to the preferred embodiment of the present invention.

An image-showing system for use on a computer or smart mobile device (the “device’) equipped with a touch panel is provided according to the preferred embodiment of the present invention. The image-showing system includes a reading unit, an identifying unit, a labeling unit, an operation interface, a thumbnail-showing unit and an executing unit. The reading unit reads image files from an image file folder or database. The identifying unit identifies characteristics of each image file read via the reading unit. The labeling unit provides each image file with a first label C1 and a second label C2. The operation interface is shown on the touch panel and receives a touch command from a user via the touch panel. The thumbnail-showing unit shows, on the operation interface, the labels C1 and C2 and image files under conditions of the operation interface in the form of thumbnails. According to the touch command received by the operation interface, the executing unit executes a corresponding process to show the contents of the image files.

The reading unit reads all of the image files from the image file folder or database in the storage medium of the device. Each of the image files includes an exchangeable image file format (“EXIF”) or attachment that carries relay data.

The identifying unit runs a program for identifying and calculating the positions and area of human faces in each image to calculate the facial area in each image and the ratio of the facial area over the total image area (the “facial ratio”). The identifying unit runs a program for identifying the color uniformity to determine the value of the color uniformity in each image. The identifying unit runs a program for reading and identifying the date/time of the relay data of each image file to determine the order of the date/time of the images. The date/time means the date/time when the image file is taken, built, accessed to, or modified.

According to the determination made by the identifying unit, the labeling unit attaches a facial area label F, a time label T and a color uniformity label U to the relay data format or attachment of each image file. The first label C1 can be the facial area label F, the time label T or the color uniformity label U. The second label C2 can be the facial area label F, the time label T or the color uniformity label U. The labels C1 and C2 are different labels. The first label C1 and the second label C2 are also included in the relay data format or attachment of each image file.

A principle for giving the facial area label F is that the image file with the highest facial ratio is given the lowest facial area label F and the image file with the lowest facial ratio is given the highest facial area label F.

For example, the principle for giving the facial area label F can be that the image file with the highest facial ratio is given F=−N/2, the image file with the lowest facial ratio is given F=N/2, and the other images are given a value from F=(−N/2)+1 to F=(N/2)−1, wherein N is the total number of the image files in the image file folder or database.

In Example 1, the total number of the image files is 2000, the image file with the highest facial ratio is given [−1000] as the facial area label F (F=−1000), the image file with the lowest facial ratio is given [1000] as the facial area label F (F=1000), and the other image files are sequentially given a value from [−999] to [999] as the facial area labels F according to the facial ratios.

A principle for giving the color uniformity label U is that the image file with the highest color uniformity (i.e., the image file with the most uniform colors) is given the lowest color uniformity label U and the image file with the lowest color uniformity (i.e., the image file with the least uniform colors) is given the highest color uniformity label U.

For example, the principle for giving the color uniformity label U can be that the image file with the highest color uniformity is given U=−N/2, the image file with the lowest color uniformity is given U=N/2, and the other images are given a value from U=(−N/2)+1 to U=(N/2)−1, wherein N is the total number of the image files in the image file folder or database.

In Example 2, the total number of the image files is 2000, the image file with the highest color uniformity is given [−1000] as the color uniformity label (U=−1000), the image file with the lowest color uniformity is given [1000] as the color uniformity label U (U=1000), and the other image files are sequentially given a value from [−999] to [999] as the color uniformity label U according to the color uniformity.

A principle for giving time label T is that the image file with the closest date/time to the current date/time is given the highest time label T, and the image file with the furthest date/time from the current date/time is given the lowest time label T. If the relay data format of an image file includes several date/time data such as the date/time when the image file is taken, the date/time when the image file is accessed to, and the date/time when the image file is modified, the furthest one of the time data to the current date/time is used to determine the time label.

For example, the principle for giving time label T can be that the image file with the closest date/time to the current date/time is given T=[−N/2], the image file with the furthest date/time from the current date/time is given T=[N/2], and the other image files are given a value from T=[(−N/2)+1] to T=[(N/2)−1], wherein N is the total number of the image files in the image file folder or database.

In example 3, the total number of the image files is 2000, the image file with the closest date/time to the current date/time is given [−1000] as the date/time label T, the image file with the furthest date/time from the current date/time is given [1000] as the date/time label T, and the other image files are sequentially given a value from [−999] to [999] as the date/time label T.

The image-showing system of the present invention includes four operation interfaces 11, 12, 13 and 14 to be selected by a user.

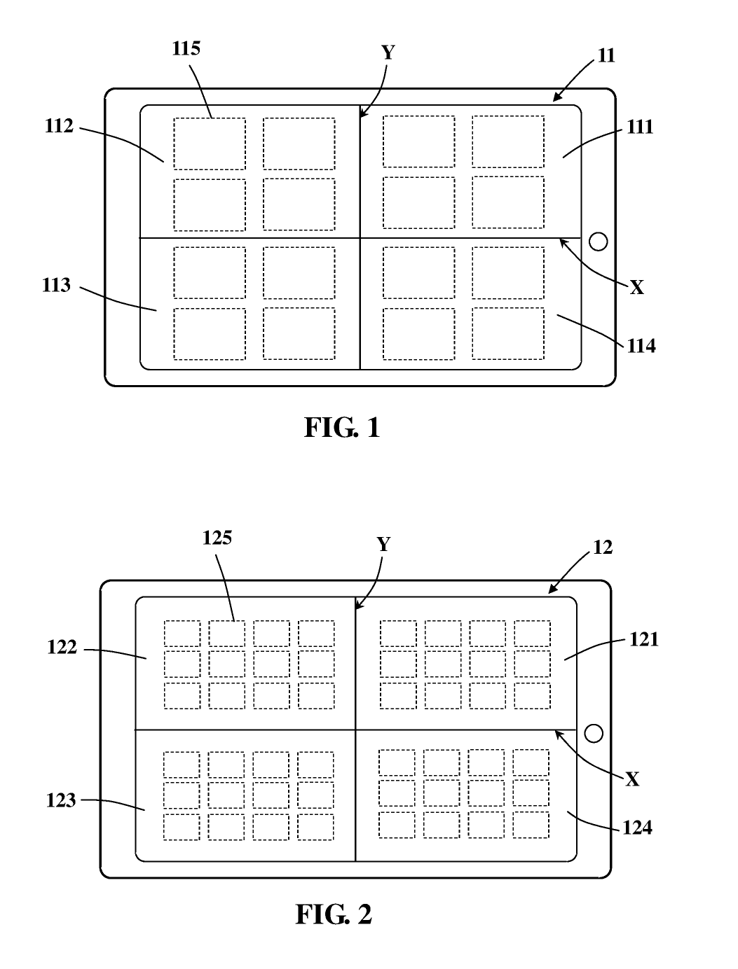

Referring to FIG. 1, the first operation interface 11 includes coordinate axes X and Y that perpendicularly intersect each other at an origin. The coordinate axes X and Y may or may not be shown on the touch panel. The smallest to largest X-axis coordinates corresponding to the facial area label F are arranged in order from left to right. The largest to smallest Y-axis coordinates corresponding to the color uniformity label U are arranged in order from top to bottom. The coordinate axes X and Y define a first quadrant 111, a second quadrant 112, a third quadrant 113 and a fourth quadrant 114 in the first operation interface 11. When the first operation interface 11 is selected, the first label C1 of each image file is the facial area label F, and the second label C2 is the color uniformity label U. The thumbnail-showing unit of the image-showing system of the present invention shows some or all of the image files with C1=F and C2=U on the first operation interface 11 in the form of thumbnails 115. The thumbnails of the image files with F=N/2 to F=1 and U=N/2 to U=1 in the first quadrant 111. The thumbnails of the image files with F=−N/2 to F=−1 and U=N/2 to U=1 are shown in the second quadrant 112. The thumbnails of the image files with F=−N/2 to F=−1 and U=−N/2 to U=−1 are shown in the third quadrant 113. The thumbnails of the image files with F=N/2 to F=1 and U=−N/2 to U=−1 are shown in the fourth quadrant 114. The thumbnails can be shown in each quadrant in any manner.

Referring to FIG. 2, the second operation interface 12 includes coordinate axes X and Y that perpendicularly intersect each other at an origin. The coordinate axes X and Y may or may not be shown on the touch panel. The smallest to largest X-axis coordinates corresponding to the facial area label F are arranged in order from left to right. The largest to smallest Y-axis coordinates corresponding to the time label T are arranged in order from top to bottom. The coordinate axes X and Y define a first quadrant 121, a second quadrant 122, a third quadrant 123, and a fourth quadrant 124 in the first operation interface 12. When the second operation interface 12 is selected, the first label C1 of each image file is the facial area label F, and the second label C2 is the time label T. The thumbnail-showing unit of the image-showing system of the present invention shows some or all of the image files with C1=F and C2=T in the form of thumbnails 125 in the second operation interface 12. The thumbnails of the image files with F=N/2 to F=1 and T=N/2 to T=1 are shown in the first quadrant 121. The thumbnails of the image files with F=−N/2 to F=−1 and T=N/2 to T=1 are shown in the second quadrant 122. The thumbnails of the image files with F=−N/2 to F=−1 and T=−N/2 to T=−1 are shown in the third quadrant 123. The thumbnails of the image files with F=N/2 to F=1 and T=−N/2 to T=−1 are shown in the fourth quadrant 124. The thumbnails can be shown in each quadrant in any manner.

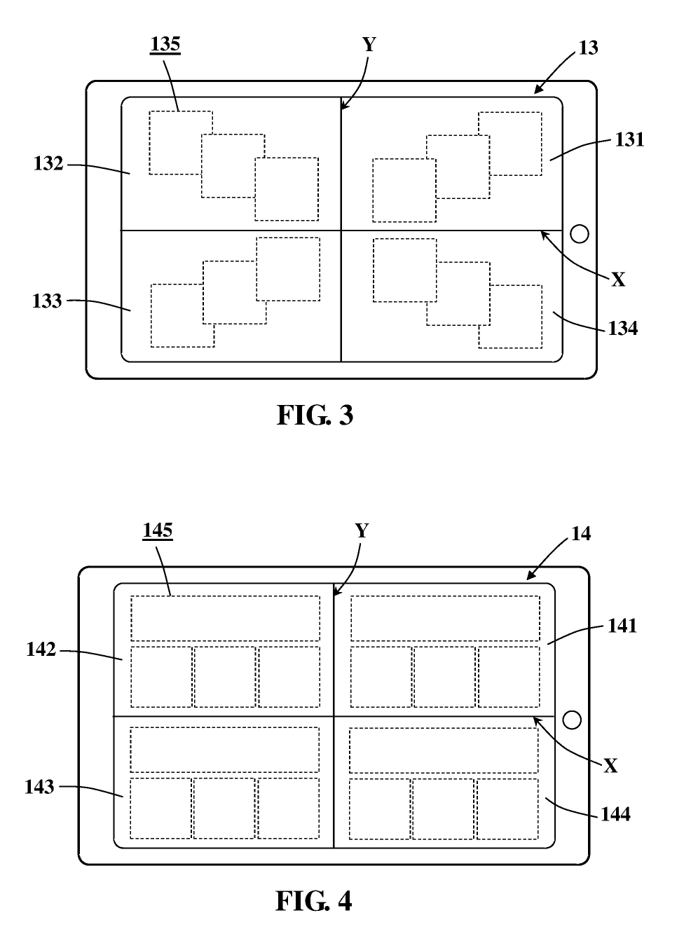

Referring to FIG 3, the third operation interface 13 includes coordinate axes X and Y that perpendicularly intersect each other at an origin. The coordinate axes X and Y may or may not be shown on the touch panel. The smallest to largest X-axis coordinates corresponding to the color uniformity label U are arranged in order from left to right. The largest to smallest Y-axis coordinates corresponding to the time label T are arranged in order from top to bottom. The coordinate axes X and Y define a first quadrant 131, a second quadrant 132, a third quadrant 133 and a fourth quadrant 134 in the third operation interface 13. When the third operation interface 13 is selected, the first label C1 of each image file is the color uniformity label U, and the second label C2 is the time label T. The thumbnail-showing unit of the image-showing system of the present invention shows some or all of the image files with C1=U and C2=T on the third operation interface 13 in the form of thumbnails 135. The thumbnails of the image files with U=N/2 to U=1 and T=N/2 to T=1 are shown in the first quadrant 131. The thumbnails of the image files with U=−N/2 to U=−1 and T=N/2 to T=1 are shown in the second quadrant 132. The thumbnails of the image files with U=−N/2 to U=−1 and T=−N/2 to T=−1 are shown in the third quadrant 133. The thumbnails of the image files with U=N/2 to U=1 and T=−N/2 to T=−1 are shown in the fourth quadrant 134. The thumbnails can be shown in each quadrant in any manner.

Referring to FIG. 4, the fourth operation interface 14 includes coordinate axes X and Y that perpendicularly intersects with each other at an origin. The coordinate axes X and Y may or may not be shown on the touch panel. The X-axis coordinate represents the facial area label F and the color uniformity label U. From left to the origin, the facial area label F varies from the smallest value to −1, i.e., F=−N/2 to F=−1. From the origin to right, the color uniformity label U varies from 1 to the largest value, i.e., U=1 to U=N/2. The Y-axis coordinate represents the time label T. The largest to smallest Y-axis coordinates are arranged in order from top to bottom. The coordinate axes X and Y define a first quadrant 141, a second quadrant 142, a third quadrant 143 and a fourth quadrant 144 in the fourth operation interface 14. When the fourth operation interface 14 is selected, the first label C1 of each image file is the facial area label F combined with the color uniformity label U, the facial area label F is (−N/2) to −1, the color uniformity label U is 1 to (N/2), and the second label C2 is the time label T. The thumbnail-showing unit of the image-showing system of the present invention shows some or all of the image files with F=(−N/2) to −1 and U=1 to (N/2) regarding C1 and C2=T in the fourth operation interface 14 in the form of thumbnails 145. The thumbnails of the image files with U=1 to U=N/2 and T=N/2 to T=1 are shown in the first quadrant 141. The thumbnails of the image files with F=−N/2 to F=−1 and T=N/2 to T=1 are shown in the second quadrant 142. The thumbnails of the image files with F=−N/2 to F=−1 and T=−N/2 to T=−1 are shown in the third quadrant 143. The thumbnails of the image files with U=N/2 to U=1 and T=−N/2 to T=−1 are shown in the fourth quadrant 144.

The image-showing system of the present invention receives the touch command from the user via one of the operation interfaces. The user touches the touch panel in a range planned by the operation interface. The way in which the user touches the touch panel and the position where the user touches the touch panel form a touch command in the operation interface. The way in which the user touches the touch panel can be a one-finger click, a one-finger drag-and-drop, a two-finger drag-and-drop, two continuous one-finger clicks or a lengthy one-finger touch.

A one-finger click and the coordinates of the corresponding contact point form a “one-finger click command.” A one-finger drag-and-drop and the coordinates of the start point and finish point of the one-finger drag-and-drop form a “one-finger drag-and-drop command.” A two-finger drag-and-drop and the distance between the coordinates of the start and finish points of two fingers form a “threshold-setting command.” Two continuous one-finger clicks regardless of the corresponding contact points form a “review list-setting command.” During the showing of images, a lengthy one-finger touch (longer than 2 seconds) on a shown image forms a “review-locking command”, and another lengthy one-finger touch (longer than 2 seconds) form a “review-unlocking command.”

The executing unit of the image-showing system of the present invention receives the “one-finger click command” and the “one-finger drag-and-drop command” and immediately builds a review list and shows images. The executing unit receives the “threshold-setting command” and immediately sets the threshold. The executing unit receives the “review list-setting command” and immediately stops the automatic showing of the images and deletes the review list. The executing unit receives the “review-locking command” and locks the image on the touch panel, and the showing system temporarily stops showing other image files until the executing unit receives the “review-unlocking command” to unlock the image files on the touch panel and continue to show other image files. During the showing of the images, the user can execute the one-finger click command, the one-finger drag-and-drop command, the threshold-setting command, the review list-setting command, the review-locking command and the review-unlocking command.

A process for building a review list and showing images in compliance with a one-finger click command will be described as follows:

Firstly, the coordinate (X, Y) of a contact point on a touch panel is obtained.

Secondly, according to Equation 1, each image file is provided with a relation value P, and the relation value P is written into a format of the image file that carries the relay data or an attachment.

P=(X−C1)²+(Y−C2)² (Equation 1)

In Equation 1, (X, Y) is the coordinate of the contact point, and C1 and C2 are respectively the first label and the second label of each image file. In the first operation interface 11, the first label is the facial area label (C1=F), and the second label is the color uniformity label (C2=U). In the second operation interface 12, the first label is the facial area label (C1=F), and the second label is the time label (C2=T). In the third operation interface 13, the first label is the color uniformity label (C1=U), and the second label is the time label (C2=T). In the fourth operation interface 14, the first label is the facial area label and the color uniformity label (C1=F, C1=U), and F=−N/2 to −1 while U=1 to N/2. Take the first operation interface 11 for example, assuming that the coordinate of the contact point is (20, 30), the facial area label F is −1000, and the color uniformity label U is −1000 for an image file, the relation value P is [20−(−1000)]²+[30−(−1000)]²=2,101,300. Similarly, the relation values P of other image files can be calculated. In the second, third or fourth operation interface, the image-showing system of the present invention calculates the relation values P of all of the image files in a similar manner.

Thirdly, the relation value P is compared with a predetermined threshold V. If the relation value P of the image file is smaller than or equal to the predetermined threshold V (P≦V), the image file is included on the review list. The minimum of the predetermined threshold is 1, and the maximum is 2(N)², wherein N is the total number of the image files. If the total number of the image files is 2000 for example, the predetermined threshold V is 1 to 8,000,000. The predetermined threshold V is adjustable in a manner to be described.

Fourthly, the executing unit activates the image displayer of the device to display the image files randomly or in the order of the relation values P of the image files on the review list.

A process for building a review list and showing the images according to a one-finger drag-and-drop command will be described.

Firstly, the coordinate of the start point (X1, Y1) and the coordinate of the finish point (X2, Y2) of the one-finger drag-and-drop are obtained.

Secondly, the coordinate of a vector (X3, Y3) of the contact point is calculated according to Equation 2.

(X3, Y3)=(X2−X1, Y2−Y1) (Equation 2)

Thirdly, for each image file, a relation value P is calculated according Equation 3. The relation value P is written in the format of the image file that carries the relay data or the attachment.

P=(X3−C1)²+(Y3−C2)² (Equation 3)

In Equation 3, (X3, Y3) is the coordinate of the vector, C1 and C2 are respectively the first label and the second label of each image file. In the first operation interface 11, the first label is the facial area label (C1=F), the second label is the color uniformity label (C2=U). In the second operation interface 12, the first label is the facial area label (C1=F), and the second label is the time label (C2=T). In the third operation interface 13, the first label is the color uniformity label (C1=U), and the second label is the time label (C2=T). In the fourth operation interface 14, the first label is the facial area label and the color uniformity label (C1=F, C1=U), and F=−N/2 to −1 and U=1 to N/2. Take the first operation interface 11 for example, assuming that the coordinate of the vector (X3, Y3) is (20, 30), the facial area label F is −1000, and the color uniformity label U is −1000 for an image file, the relation value P is [20−(−1000)]²+[30−(−1000)]²=2,101,300. Similarly, the relation values P of other image files are calculated. In the second, third or fourth operation interface, the image-showing system of the present invention calculates the relation values P of all of the image files in a similar manner.

Fourthly, the relation value P is compared with a predetermined threshold V. If the relation value P of the image file is smaller than or identical to the predetermined threshold V (P≦V), the image file is included in the review list. The minimum of the predetermined threshold is 1, and the maximum is 2(N)², wherein N is the total number of the image files. If the total number of the image files is 2000 for example, the predetermined threshold V is 1 to 8,000,000. The predetermined threshold V is adjustable in a manner to be described.

Fifthly, the executing unit activates the image displayer of the device to show the image files randomly or in the order of the relation values P of the image files on the review list.

A process for setting the predetermined threshold V according to the threshold-setting command will be described.

Firstly, the coordinates of the start and finish points of a two-finger drag-and-drop are obtained. The coordinate of the start point of the first finger is (X01, Y01). The coordinate of the finish point of the first finger is (X02, Y02). The coordinate of the start point of the second finger is (X03, Y03). The coordinate of the finish point of the second finger is (X04, Y04).

Secondly, DN1, which is the square of the distance between the start point of the first finger and the start point of the second finger, is calculated according to Equation 4, and DN2, which is the square of the distance between the finish point of the first finger and the finish point of the second finger, is calculated according to Equation 5.

DN1=(X01−X03)²+(Y01−Y03)² (Equation 4)

DN2=(X02−X04)²+(Y02−Y04)² (Equation 5)

Thirdly, if DN1>DN2, i.e., the fingers are moved toward each other, the predetermined threshold V is reduced. If DN1<DN2, i.e., the fingers are moved away from each other, the predetermined threshold V is increased. The predetermined threshold V can be increased or reduced according to the difference between DN1 and DN2. The predetermined threshold V can be increased or reduced in proportion to the difference between DN1 and DN2. The smaller the predetermined threshold V is, the more accurate is the image file included in the review list comply with the touch command

The present invention has been described via the illustration of the preferred embodiment. Those skilled in the art can derive variations from the preferred embodiment without departing from the scope of the present invention. Therefore, the preferred embodiment shall not limit the scope of the present invention defined in the claims.

What is claimed is:

1. An image-showing system for use in a computer or smart mobile device equipped with a touch panel, the image-showing system comprising:
a reading unit for reading image files from an image file folder;
an identifying unit for identifying characteristics of each of the image files read by the reading unit, wherein the identifying unit runs a program for identifying positions of faces and calculating facial areas in each of the image files to calculate a ratio of the facial areas over total image area, the identifying unit runs a program for identifying color uniformity to calculate value of color uniformity of each of the image files, and the identifying unit runs a program for reading and identifying date/time data of relay data of each of the image files to determine the date/time of each of the image files;
a labeling unit for providing each of the image files with a first label (C1) and a second label (C2) according to results provided by the identifying unit, wherein the labeling unit provides each of the image files with a facial area label (F) according to the ratio of the facial areas over the total image area provided by the identifying unit, the labeling unit provides each of the image files a color uniformity label (U) according to an order of the color uniformity values provided by the identifying unit, the labeling unit provides each of the image files a time label (T) according to an order of the date/time provided by the identifying unit, the first label (C1) is selected from the group consisting of the facial area label (F), the color uniformity label (U) and the time label (T), the second label (C2) is selected from the group consisting of the facial area label (F), the color uniformity label (U) and the time label (T), and the first label (C1) and the second label (C2) are different labels;
an operation interface shown on the touch panel and adapted for receiving a touch command from a user via the touch panel, wherein the operation interface includes coordinate axes X and Y that perpendicularly intersect each other at an origin, smallest to largest X-axis coordinates corresponding to the first label (C1) are arranged in order from left to right, largest to smallest Y-axis coordinates corresponding to the second label (C2) are arranged in order from top to bottom; and
an executing unit for executing a process corresponding to the touch command received by the operation interface, wherein when the touch command is a one-finger click command given by a user using one finger to click the touch panel, the process executed by the executing unit comprises the steps of:
obtaining a coordinate (X, Y) of position of a contact point on the touch panel;
providing each of the image files with a relation value (P) according to:
P=(X−C1)²+(Y−C2)^{2;}
comparing the relation value (P) with a predetermined threshold (V), and including an image file in a review list if the relation value (P) of the image file is smaller than or identical to the predetermined threshold (V); and
showing the image files randomly or in order of the relation values P of the image files on the review list.

2. The image-showing system according to claim 1, wherein the labeling unit provides F=−N/2 for one of the image files with the highest ratio of the facial areas over the total image area among the image files, F=N/2 for one of the image files with the lowest ratio of the facial areas over the total image area among the image files, and F=(−N/2)+1 to F=(N/2)−1 for the others of the image files by interpolation, and N is total number of the image files read by the reading unit.

3. The image-showing system according to claim 2, wherein the labeling unit provides U=−N/2 for one of the image files with the largest value of color uniformity among the image files, U=N/2 for one of the image files with the smallest value of color uniformity among the image files, and U=(−N/2)+1 to U=(N/2)−1 for the others of the image files by interpolation.

4. The image-showing system according to claim 3, wherein the labeling unit provides T=−N/2 for one of the image files with the earliest date/time among the image files, T=N/2 for one of the image files with the latest date/time among the image files, and T=(−N/2)+1 to T=(N/2)−1 for the others of the image files by interpolation.

5. The image-showing system according to claim 4, wherein the operation interface is selected from a group consisting of a first operation interface, a second operation interface, a third operation interface and a fourth operation interface.

6. The image-showing system according to claim 5, wherein in the first operation interface, the first label (C1) of each of the image files is the facial area label (F) so that C1=F, and the second label (C2) of each of the image files is the color uniformity label (U) so that C2=U.

7. The image-showing system according to claim 6, further comprising a thumbnail-showing unit for showing some or all of the image files with C1=F and C2=U in the form of thumbnails in the first operation interface, wherein the thumbnails of the image files with F=N/2 to F=1 and U=N/2 to U=1 are shown in the first quadrant of the first operation interface, the thumbnails of the image files with F=−N/2 to F=−1 and U=N/2 to U=1 are shown in the second quadrant of the first operation interface, the thumbnails of the image files with F=−N/2 to F=−1 and U=−N/2 to U=−1 are shown in the third quadrant of the first operation interface, and the thumbnails of the image files with F=N/2 to F=1 and U=−N/2 to U=−1 are shown in the fourth quadrant of the first operation interface.

8. The image-showing system according to claim 5, wherein in the second operation interface, the first label (C1) of each of the image files is the facial area label (F) so that C1=F, and the second label (C2) of each of the image files is the time label (T) so that C2=T.

9. The image-showing system according to claim 8, further comprising a thumbnail-showing unit for showing some or all of the image files with C1=F and C2=T in the form of thumbnails in the second operation interface, wherein the thumbnails of the image files with F=N/2 to F=1 and T=N/2 to T=1 are shown in the first quadrant of the second operation interface, the thumbnails of the image files with F=−N/2 to F=−1 and T=N/2 to T=1 are shown in the second quadrant of the second operation interface, the thumbnails of the image files with F=−N/2 to F=−1 and T=−N/2 to T=−1 are shown in the third quadrant of the second operation interface, and the thumbnails of the image files with F=N/2 to F=1 and T=−N/2 to T=−1 are shown in the fourth quadrant of the second operation interface.

10. The image-showing system according to claim 5, wherein in the third operation interface, the first label (C1) of each of the image files is the color uniformity label (U) so that C1=U, and the second label (C2) of each of the image files is the time label (T) so that C2=T.

11. The image-showing system according to claim 10, further comprising a thumbnail-showing unit for showing some or all of the image files with C1=U and C2=T in the third operation interface, wherein the thumbnails of the image files with U=N/2 to U=1 and T=N/2 to T=1 are shown in the first quadrant of the third operation interface, the thumbnails of the image files with U=−N/2 to U=−1 and T=N/2 to T=1 are shown in the second quadrant of the third operation interface, the thumbnails of the image files with U=−N/2 to U=−1 and T=−N/2 to T=−1 are shown in the third quadrant of the third operation interface, and the thumbnails of the image files with U=N/2 to U=1 and T=−N/2 to T=−1 are shown in the fourth quadrant of the third operation interface.

12. The image-showing system according to claim 5, wherein in the fourth operation interface, the first label (C1) of each of the image files is the facial area label (F) and the color uniformity label (U), the facial area label (F) is (−N/2) to −1, and the color uniformity label (U) is 1 to (N/2) so that C1=F=(−N/2) to −1 and C1=U=1 to (N/2), and the second label (C2) of each of the image files is the time label (T) so that C=T.

13. The image-showing system according to claim 12, further comprising a thumbnail-showing unit for showing some or all of the image files with C1=F=(−N/2) to −1 and C1=U=1 to (N/2) and C2=T in the form of thumbnails in the fourth operation interface, wherein the thumbnails of the image files with U=1 to U=N/2 and T=N/2 to T=1 are shown in the first quadrant of the fourth operation interface, the thumbnails of the image files with F=−N/2 to F=−1 and T=N/2 to T=1 are shown in the second quadrant of the fourth operation interface, the thumbnails of the image files with F=−N/2 to F=−1 and T=−N/2 to T=−1 are shown in the third quadrant of the fourth operation interface, and the thumbnails of the image files with U=N/2 to U=1 and T=−N/2 to T=−1 are shown in the fourth quadrant of the fourth operation interface.

14. The image-showing system according to claim 1, wherein when the touch command is a one-finger drag-and-drop command given by the user using one finger to drag and drop on the touch panel, the process executed by the executing unit according to the one-finger drag-and-drop command comprises the steps of:
obtaining the coordinate of the start point (X1, Y1) and the coordinate of the finish point (X2, Y2) of the one-finger drag-and-drop command;
providing the coordinate of a vector (X3, Y3) according to:
(X3, Y3)=(X2−X1, Y2−Y1);
providing each of the image files with a relation value P′ according to:
P′=(X3−C1)²+(Y3−C2)²;
comparing the relation value P′ with the predetermined threshold V, and including an image file in a review list if the relation value P′ of the image file is smaller than or identical to the predetermined threshold V (P′≦V); and
showing the image files randomly or in order of the relation values P′ of the image files on the review list.

15. The image-showing system according to claim 1, wherein when the touch command is a threshold-setting command given by the user using two fingers to drag and drop on the touch panel, the process executed by the executing unit according to the threshold-setting command comprises the steps of:
obtaining the coordinate of the start point and the coordinate of the finish point of each of the two fingers of the two-finger drag-and-drop, wherein the coordinate of the start point of the first finger is (X01, Y01), the coordinate of the finish point of the first finger is (X02, Y02), the coordinate of the start point of the second finger is (X03, Y03), and the coordinate of the finish point of the second finger is (X04, Y04);
obtaining DN1, square of distance between the start points of the first and second fingers, and obtaining DN2, square of distance between the finish points of the first and second fingers, according:
DN1=(X01−X03)²+(Y01−Y03)²
DN2=(X02−X04)²+(Y02−Y04)²;
indicating that the first and second fingers are moved toward each other and reducing the predetermined threshold V if DN1>DN2, or indicating that the first and second fingers are moved away from each other and increasing the predetermined threshold V if DN1<DN2, wherein the predetermined threshold V can be increased or reduced according to difference between DN1 and DN2, or the predetermined threshold V can be increased or reduced in proportion to the difference between DN1 and DN2.

16. The image-showing system according to claim 1, wherein when the touch command is a review list-setting command given by the user using one finger to continuously click the touch panel twice, the executing unit stops the automatic showing of the images and deletes the review list according to the review list-setting command.

17. The image-showing system according to claim 1, wherein when the touch command is a review-locking command given by the user using one finger to provide a touch longer than a preset time duration on the touch panel while the executing unit is showing the image files, the executing unit locks the image files on the touch panel and stops displaying the other image files according to the review-locking command.

18. The image-showing system according to claim 17, wherein when the touch command is a review-unlocking command given by the user using one finger to provide another touch longer than a preset time duration on the touch panel while the executing unit has executed the review-locking command and the image files are locked on the touch panel, the executing unit unlocks the image files on the touch panel and continues to display the other image files according to the review-unlocking command.
